(19) United States
(12) Patent Application Publication
(10) Pub. No.: US 2026/0368872 A1
(43) Pub. Date: Nov. 19, 2026

(54) INSPECTION DEVICE, INSPECTION METHOD, AND INSPECTION PROGRAM

(71) Applicant: NTT, Inc., Tokyo (JP)

(72) Inventors: Yuki YAMANAKA, Musashino-shi, Tokyo (JP); Hiroyoshi TAKIGUCHI, Musashino-shi, Tokyo (JP); Masanori SHINOHARA, Musashino-shi, Tokyo (JP); Takuya MINAMI, Musashino-shi, Tokyo (JP); Yasunori WADA, Musashino-shi, Tokyo (JP); Yo KANEMOTO, Musashino-shi, Tokyo (JP); Hiroto NOMURA, Musashino-shi, Tokyo (JP)

(73) Assignee: NTT. Inc., Tokyo (JP)

(21) Appl. No.: 19/138,693

(22) PCT Filed: Dec. 26, 2022
(86) PCT No.: PCT/JP2022/047903

§ 371 Date: Jun. 13, 2025

(51) Int. Cl. G06T 7/00; G06Q 30/018; G06T 7/40; G06V 20/64

(52) U.S. Cl. CPC G06T 7/0002; G06Q 30/018; G06T 7/40; G06V 20/653

(57) ABSTRACT

An inspection device includes a memory and processing circuitry configured to receive first appearance information that is appearance information of an article captured by a user, calculate a score indicating a degree of deterioration of the article indicated in the received first appearance information of the article by comparing the first appearance information with second appearance information that is appearance information of the article in a brand-new state provided from a manufacturer of the article, and transmit the calculated score indicating the degree of deterioration in appearance of the article to a terminal of the user.

### TECHNICAL FIELD

The present invention relates to an inspection device, an inspection method, and an inspection program for inspecting an article to be sold on a flea market site (flea market site) or the like.

### BACKGROUND ART

Conventionally, with the spread of a flea market application and the like, the market for secondhand articles and almost-new articles has been expanding, and not only the value of an article itself but also the resale value thereof has been emphasized.

Meanwhile, when a purchaser purchases an article on a flea market site, the purchaser needs to determine the quality of the article only from limited information on the flea market site (for example, several photographs, information provided from a seller, reputation information for the seller, and the like). These pieces of information are information that can be disguised relatively easily, which causes troubles such as delivery of an article different from the intention of the purchaser.

### CITATION LIST

### Non Patent Literature

Non Patent Literature 1: Fusei tenbai boushi gijutsu (in Japanese) (Unauthorized resale prevention technique), [online], [searched on December 8, 2022], the Internet <URL:https://eltes-solution. jp/issue/customer-support-2>
Non Patent Literature 2: Furima apuri toukou kanshi gijutsu (in Japanese) (Flea market application post monitoring technique), [online], [searched on Dec. 8, 2022], the Internet <URL:https://monitor.adish.co.jp/tag/%E3%83%95%E3%83%AA%E3% 83%9E%E3%82%A2%E3%83%97%E3%83%AA/?post type=price>

### SUMMARY OF INVENTION

### Technical Problem

However, conventionally, there has been no means for inspecting a state of deterioration in appearance of an article sold and bought on a flea market site. Therefore, an object of the present invention is to provide a means for inspecting a state of deterioration in appearance of an article sold and bought on a flea market site.

### Solution to Problem

In order to solve the above-described problem, the present invention includes: a reception unit configured to receive first appearance information that is appearance information of an article captured by a user; a score calculation unit configured to calculate a score indicating a degree of deterioration of the article indicated in the received first appearance information of the article by comparing the first appearance information with second appearance information that is appearance information of the article in a brand-new state provided from a manufacturer of the article; and a transmission unit configured to transmit the calculated score indicating the degree of deterioration in appearance of the article to a terminal of the user.

### Advantageous Effects of Invention

According to the present invention, it is possible to inspect a state of deterioration in appearance of an article sold and bought on a flea market site.

### BRIEF DESCRIPTION OF DRAWINGS

FIG. 1 is a diagram for describing an outline of an inspection device.

FIG. 2 is a diagram illustrating a configuration example of a system including the inspection device.

FIG. 3 is a flowchart illustrating an example of a processing procedure executed by the inspection device.

FIG. 4 is a diagram illustrating a computer that executes an inspection program.

### DESCRIPTION OF EMBODIMENTS

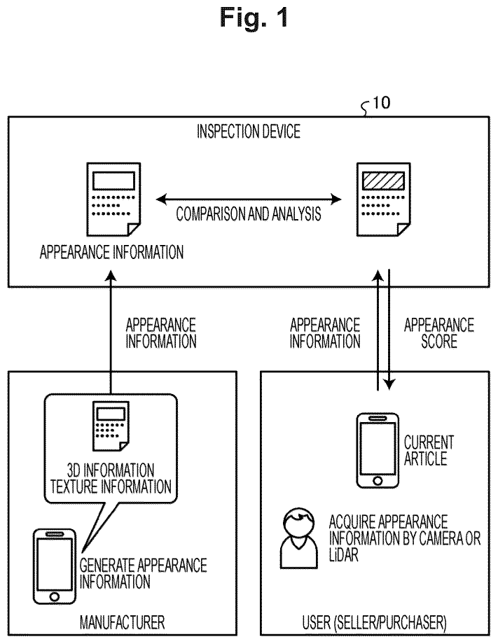

Hereinafter, a mode for carrying out the present invention (embodiment) will be described with reference to the drawings. The present invention is not limited to the present embodiment.

[Outline] First, an outline of an inspection device 10 according to the present embodiment will be described with reference to FIG. 1. The inspection device 10 inspects a state of deterioration in appearance of an article sold and bought on a flea market site (hereinafter, appropriately abbreviated as “flea market site”), and returns a result of the inspection (appearance score) to a terminal of a user who sells or buys the article.

First, the inspection device 10 acquires appearance information (3D information and texture information) of each article in a brand-new state provided from a manufacturer. Thereafter, the inspection device 10 acquires appearance information of an article (current article) captured by a camera or light detection and ranging (LiDAR) of a smartphone of a user (for example, a seller or a purchaser of a secondhand article on a flea market site).

The inspection device 10 compares and analyzes the appearance information of the article (current article) acquired from the user with the appearance information of the article in the brand-new state acquired from the manufacturer, thereby calculating a score (appearance score) indicating the degree of deterioration in appearance of the current article. The inspection device 10 then transmits the calculated appearance score to a terminal of the user.

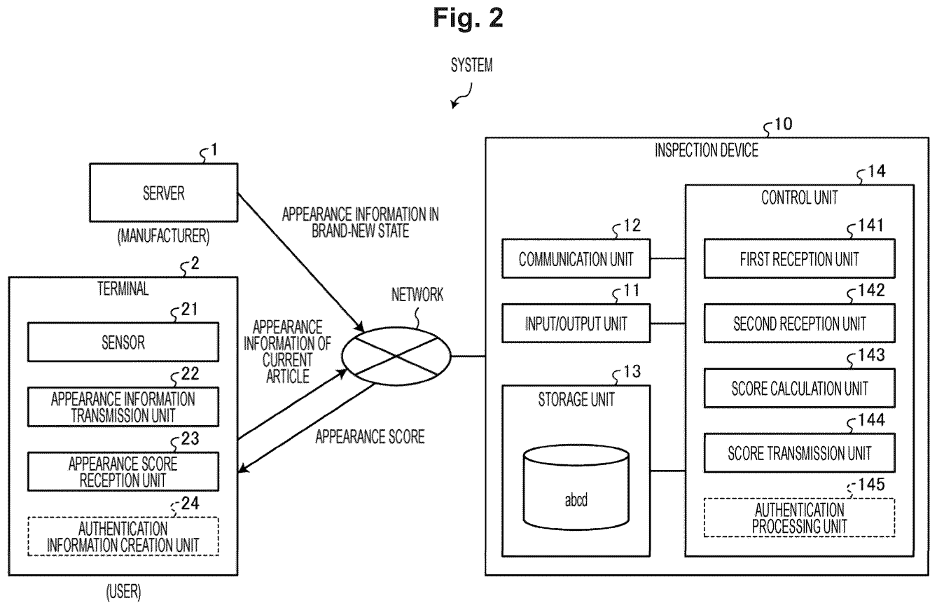

As a result, for example, if the user is a seller of an article on a flea market site, the appearance score of the article acquired from the inspection device 10 can be used as quality information to be added at the time of selling the article on the flea market site. In addition, if the user is a purchaser of an article on a flea market site, the appearance score of the article can be used for inspection work of the article.

[Configuration example] Next, a configuration example of a system including the inspection device 10 will be described with reference to FIG. 2. The system includes, for example, a server 1 of a manufacturer, a terminal 2 of a user, and the inspection device 10. The numbers of the servers 1, the terminals 2, and the inspection devices 10 are not limited to the numbers illustrated in FIG. 2.

The server 1 is a server of a manufacturer, and holds appearance information of each article in a brand-new state. The terminal 2 is a terminal of a user who sells or buys an article on a flea market site or the like. The terminal 2 includes a sensor 21, an appearance information transmission unit 22, and an appearance score reception unit 23. The terminal 2 is implemented by a smartphone, a personal computer, or the like that can communicate with the inspection device 10 via a network such as the Internet.

An authentication information creation unit 24 indicated by a broken line is equipped in some cases and is not be equipped other cases, and a case where the authentication information creation unit 24 is equipped will be described later.

The sensor 21 captures appearance information of an article (current article) with a camera or light detection and ranging (LiDAR). Note that the sensor 21 may be provided outside the terminal 2. The appearance information transmission unit 22 transmits the appearance information of the article obtained by the sensor 21 to the inspection device 10.

The appearance information includes, for example, 3D information and texture information of the article acquired by the sensor 21. The 3D information of the article is information in which the appearance of the article is three-dimensionally expressed by a wire frame, a surface, or a solid. Furthermore, the texture information of the article is information indicating the color and texture of the surface of a specific portion of the article. The texture information is acquired from, for example, an image of the article captured by the sensor 21 together with a color sample for color tone correction.

Note that, in a case where the 3D information of the article cannot be acquired since the terminal 2 is not equipped with LiDAR or the like, the appearance information of the article transmitted by the appearance information transmission unit 22 may be only the texture information of the article.

The appearance score reception unit 23 receives an appearance score of the article from the inspection device 10. As a result, the user of the terminal 2 can acquire an evaluation result of the deterioration state of the appearance of the article to be sold and bought on the flea market site.

For example, if the user of the terminal 2 is a seller of an article on a flea market site, the appearance score of the article can be used as additional information indicating the quality of the article. In addition, for example, if the user of the terminal 2 is a purchaser of an article on a flea market site, a received appearance score of the article can be used for inspection work of the article.

Next, the inspection device 10 will be described. The inspection device 10 includes, for example, an input/output unit 11, a communication unit 12, a storage unit 13, and a control unit 14.

The input/output unit 11 is an interface that controls input and output of various types of data. The communication unit 12 is an interface for communicating with other devices via a network. For example, the communication unit 12 receives appearance information of each article in a brand-new state from the server 1 and receives appearance information of a current article from the terminal 2 via a network.

The storage unit 13 stores data, programs, and the like that are referred to when the control unit 14 executes various types of processing. The storage unit 13 is implemented with a semiconductor memory element such as a random access memory (RAM) or a flash memory, or a storage device such as a hard disk or an optical disk. For example, the storage unit 13 stores appearance information and the like of each article in a brand-new state.

The control unit 14 controls the entire inspection device 10. The control unit 14 includes a first reception unit 141, a second reception unit 142, a score calculation unit 143, and a score transmission unit 144. An authentication processing unit 145 indicated by a broken line is equipped in some cases and is not be equipped other cases, and a case where the authentication processing unit 145 is equipped will be described later. Note that the function of each unit of the control unit 14 is implemented, for example, when a central processing unit (CPU) executes a program stored in the storage unit 13.

The first reception unit 141 receives appearance information of each article in a brand-new state from the server 1. The received appearance information of each article in the brand-new state is stored in the storage unit 13. In addition, the second reception unit 142 receives appearance information of an article (current article) from the terminal 2.

The score calculation unit 143 compares the appearance information of the article (current article) transmitted from the terminal 2 with the appearance information of the article in the brand-new state to calculate an appearance score indicating the degree of deterioration in appearance of the article (current article).

For example, when comparing 3D information included in these pieces of appearance information, the score calculation unit 143 uses point group comparison (see Document 1).

Document 1: https://www.jstage.jst.go.jp/article/pscjspe/2019S/0/2019S_91/pdf

Furthermore, for example, when comparing texture information included in these pieces of appearance information, the score calculation unit 143 performs normalization using the Gray-Level Co-occurrence Matrix (GLCM) or the like, measurement of non-uniformity using entropy or the like, measurement of color tone, or the like.

For example, as a result of comparing the 3D information included in these pieces of appearance information and comparing the texture information included in these pieces of appearance information, the score calculation unit 143 calculates the appearance score to be lower as the difference from the appearance information of the article in the brand-new state is larger.

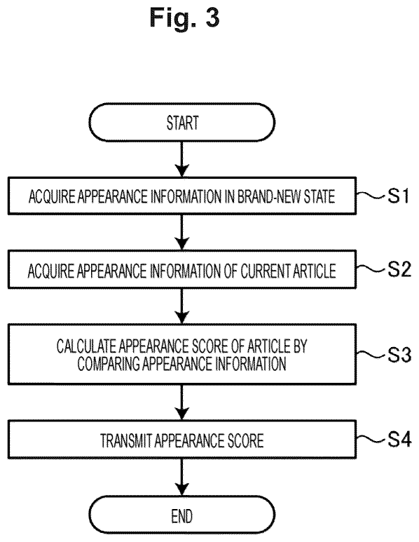

The score transmission unit 144 transmits the appearance score of the article (current article) calculated by the score calculation unit 143 to the terminal 2.

[Example of processing procedure] Next, an example of a processing procedure executed by the inspection device 10 will be described with reference to FIG. 3. First, the first reception unit 141 of the inspection device 10 acquires appearance information of each article in a brand-new state from the server 1 (S1). The first reception unit 141 then stores the acquired appearance information of each article in the brand-new state in the storage unit 13.

After S1, the second reception unit 142 acquires appearance information of an article (current article) from the terminal 2 (S2). The score calculation unit 143 then reads the appearance information of the article in the brand-new state from the storage unit 13. Thereafter, the score calculation unit 143 calculates an appearance score of the article by comparing the appearance information of the article (current article) with the appearance information of the article in the brand-new state (S3).

The score transmission unit 144 then transmits the appearance score calculated in S3 to the terminal 2 (S4).

In this way, the inspection device 10 can inspect the degree of deterioration in appearance of an article sold on a flea market site and notify a seller or a purchaser of the article of the inspection result (appearance score).

[Another embodiment] Note that, in a case of determining that appearance information transmitted from the terminal 2 is appearance information related to another article acquired in the past, the inspection device 10 may set the appearance information as information not to be processed. In this case, the terminal 2 further includes the authentication information creation unit 24 that creates authentication information of appearance information, and the inspection device 10 further includes the authentication processing unit 145 (see FIG. 2).

The authentication information creation unit 24 creates authentication information that is information certifying a situation in which appearance information of an article (current article) is captured. The authentication information creation unit 24 creates the authentication information including time and place (for example, GPS information) when and where the appearance information of the current article is acquired, information on a user, one-time information (for example, acquired by the user imaging a one-time password together with the current article with a camera), and the like. The appearance information transmission unit 22 of the terminal 2 then includes the created authentication information in the appearance information of the current article and transmits the obtained appearance information to the inspection device 10.

The authentication processing unit 145 of the inspection device 10 performs authentication processing of the appearance information transmitted from the terminal 2 by using the authentication information added to the appearance information. For example, the authentication processing unit 145 performs the authentication processing based on whether the time indicated by the authentication information added to the appearance information is within a predetermined time from the current time. The score calculation unit 143 sets the appearance information for which the authentication processing has succeeded as a processing target.

As described above, the inspection device 10 performs authentication processing on appearance information transmitted from the terminal 2 by using authentication information, whereby, for example, in a case where the appearance information transmitted from the terminal 2 is appearance information related to another article acquired in the past, the appearance information can be set as information not to be processed.

[System configuration and the like] Furthermore, each component of each illustrated unit is functionally conceptual, and does not necessarily have to be physically configured as illustrated. That is, specific forms of distribution and integration of the devices are not limited to the illustrated forms, and all or a part of the devices can be functionally or physically distributed and integrated in any units according to various loads, usage conditions, and the like. Furthermore, all or any part of the processing functions performed in each device can be implemented by a CPU and a program executed by the CPU, or can be implemented as hardware by wired logic.

Furthermore, in the processing described in the above-described embodiments, all or a part of the processing described as being automatically performed can be manually performed, or all or a part of the processing described as being manually performed can be automatically performed by a known method. In addition, the processing procedures, the control procedures, the specific names, and the information including various types of data and parameters illustrated in the document and the drawings can be freely changed unless otherwise specified.

[Program] The above-described inspection device 10 can be implemented by installing a program (inspection program) as package software or online software in a desired computer. For example, causing an information processing device to execute the above program enables the information processing device to function as the inspection device 10. The information processing device herein includes a mobile communication terminal such as a smartphone, a mobile phone, or a personal handy-phone system (PHS), and further includes a terminal such as a personal digital assistant (PDA).

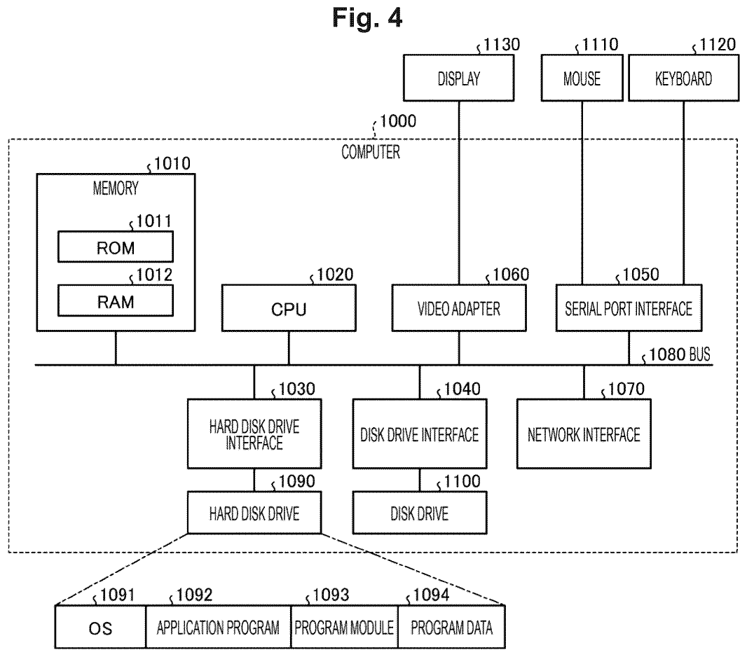

FIG. 4 is a diagram illustrating an example of a computer that executes the inspection program. A computer 1000 includes, for example, a memory 1010 and a CPU 1020.

The computer 1000 also includes a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100.

The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, a program that defines each piece of processing executed by the inspection device 10 is implemented as the program module 1093 in which codes executable by the computer are described. The program module 1093 is stored in, for example, the hard disk drive 1090. For example, the program module 1093 for executing processing similar to the functional configuration in the inspection device 10 is stored in the hard disk drive 1090. Note that the hard disk drive 1090 may be replaced with a solid state drive (SSD).

Furthermore, the data used in the processing of the above-described embodiments is stored as the program data 1094, for example, in the memory 1010 or the hard disk drive 1090. The CPU 1020 then reads the program module 1093 and the program data 1094 stored in the memory 1010 or the hard disk drive 1090 into the RAM 1012 as necessary, and executes the program module 1093 and the program data 1094.

Note that the program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (local area network (LAN), wide area network (WAN), or the like). The program module 1093 and the program data 1094 may be read by the CPU 1020 from the other computer via the network interface 1070.

### REFERENCE SIGNS LIST

10 Inspection device
11 Input/output unit
12 Communication unit
13 Storage unit
14 Control unit
21 Sensor
22 Appearance information transmission unit
23 Appearance score reception unit
24 Authentication information creation unit
141 First reception unit
142 Second reception unit
143 Score calculation unit
144 Score transmission unit
145 Authentication processing unit

1. An inspection device comprising:
a memory; and
processing circuitry configured to:
receive first appearance information that is appearance information of an article captured by a user;
calculate a score indicating a degree of deterioration of the article indicated in the received first appearance information of the article by comparing the first appearance information with second appearance information that is appearance information of the article in a brand-new state provided from a manufacturer of the article; and
transmit the calculated score indicating the degree of deterioration in appearance of the article to a terminal of the user.

2. The inspection device according to claim 1, wherein
the second appearance information of the article
includes three-dimensional information and texture information of the article, and
the first appearance information of the article
includes at least one of three-dimensional information and texture information of the article.

3. The inspection device according to claim 2, wherein
the three-dimensional information of the article
is information in which the article is three-dimensionally expressed by a wire frame, a surface, or a solid, and
the processing circuitry is further configured to:
calculate the score indicating the degree of deterioration of the article by performing point group comparison between the three-dimensional information of the first appearance information of the article and the three-dimensional information of the second appearance information of the article.

4. The inspection device according to claim 2, wherein
the processing circuitry is further configured to:
compare the texture information of the first appearance information of the article with the texture information of the second appearance information of the article by performing at least one of normalization using a Gray-Level Co-occurrence Matrix (GLCM), quantification of non-uniformity by measurement of entropy, and measurement of color tone.

5. The inspection device according to claim 1, wherein the processing circuitry is further configured to:
perform authentication processing of the received first appearance information of the article by using authentication information that is added to the first appearance information of the article and certifies at least one of a date and time and a place when and where the article is captured and information on the user, and
set the first appearance information of the article for which the authentication processing has succeeded as a processing target.

6. An inspection method executed by an inspection device, the inspection method comprising:
receiving first appearance information that is appearance information of an article captured by a user;
calculating a score indicating a degree of deterioration of the article indicated in the received first appearance information of the article by comparing the first appearance information with second appearance information that is appearance information of the article in a brand-new state provided from a manufacturer of the article; and
transmitting the calculated score indicating the degree of deterioration in appearance of the article to a terminal of the user.

7. A non-transitory computer-readable recording medium storing therein an inspection program that causes a computer to execute a process comprising:
receiving first appearance information that is appearance information of an article captured by a user;
calculating a score indicating a degree of deterioration in appearance of the article indicated in the received first appearance information of the article by comparing the first appearance information with second appearance information that is appearance information of the article in a brand-new state provided from a manufacturer of the article; and
transmitting the calculated score indicating the degree of deterioration of the article to a terminal of the user.
